(19) United States
(12) Patent Application Publication
(10) Pub. No.: US 2010/0094183 A1
(43) Pub. Date: Apr. 15, 2010

(54) DEVICE FOR RELEAVING LABOR PAIN

(76) Inventor: Harel Golombek, Netanya (IL)

Correspondence Address: AVIA KAFRI, 22 SHDEROT CHEN ST, TEL AVIV, 84186, IL

(21) Appl. No.: 12/449,984

(22) PCT Filed: Mar. 6, 2008
(86) PCT No.: PCT/IL2008/000298

§ 371 Date: Sep. 4, 2009

Related U.S. Application Data
(60) Provisional application No. 60/905,129, filed on Mar. 7, 2007.

(51) Int. Cl. A61H 7/00

(52) U.S. Cl. 601/112; 601/134

(57) ABSTRACT

Device for relieving labor pains (DRLP), pains associated with pregnancy and/or menstrual period includes a pressurizing unit, the active face of which is attachable to a user's body facing her sacrum. Harness adapted and arranged to wrap the waist of the user is equipped with stretching stripes providing for urging the tips of pressurizing elements of the pressurizing unit towards targeted sacral foramina. The location of a pressurizing element relative to the back segment of the harness is changeable, thereby a user may adjust it to press against targeted acu-points. The pressurizing elements are rotatable by user's selection. The DRLP is operative in two modes of operation, one of which is the static mode in which the pressurizing elements are kept still. In the dynamic mode the pressurizing elements eccentrically and/or centrically rotate at rotational speeds selectable by the user.

### FIELD OF THE INVENTION

The present invention relates in general to massaging devices. More particularly the present invention relates to a device having movable pressurizing elements and a harness fitted to be worn by a parturient and/or pregnant woman, providing for pressurizing the surface of the user's body at points facing her sacral foramina.

### BACKGROUND OF THE INVENTION

Massaging equipment is common in the market place. In U.S. Pat. No. 7,125,390 a hand-held body massager having a massage unit housed in a transverse body is disclosed. A pair of elongated arms pivotally connected to the massager body provides for orienting the massage unit disposed therebetween. Each arm has a handle to be held by a user while urging the massager towards a targeted surface of the user's body. The massaging unit has a motorized eccentric drive providing for reciprocally rotating a massage formation relative to the massager body. The disclosed massage formation includes pressurizing elements, such as spherical protrusions, some of which are replaceable by elements of a different geometrical shape by the user.

Massaging and/or acupressure treatment normally provides for relieving pains. Acupressure techniques for relieving labor pains are known. A pair of acu-points known to be effective for relieving labor pains named Ciliao (normally designated by BI 32) faces the sacral foramina that are second from the top. In FIG. 1 an isometric view of sacrum 10 is shown in which these foramina are designated by 12. Guides for self training, as well as therapists providing such treatment and/or training users in applying acupressure techniques are common.

However acupressure treatment that is manually applied might be too complicated to be accomplished by a parturient experiencing heavy pain. Therefore there is a need for a device providing a pregnant woman and/or parturient to effectively treat herself by pressurizing at her sacral foramina.

### BRIEF DESCRIPTION OF THE DRAWINGS

FIG. 1 is an isometric view of a sacrum;

FIG. 2 is an isometric view of a device for relieving labor pain according to an embodiment of the present invention worn by a pregnant woman;

FIG. 3 is an elevational view in which a detail of the pressurizing unit of is a device for relieving labor pains in accordance with another embodiment of the present invention is shown;

FIG. 4 is a scheme describing the motion of the tips of pressurizing elements of a device for relieving labor pain according to a preferred embodiment of the present invention across the surface of the body of a user;

FIG. 5 is a scheme describing the setup of the tips of the pressurizing elements of a device for relieving labor pain according to an embodiment of the present invention;

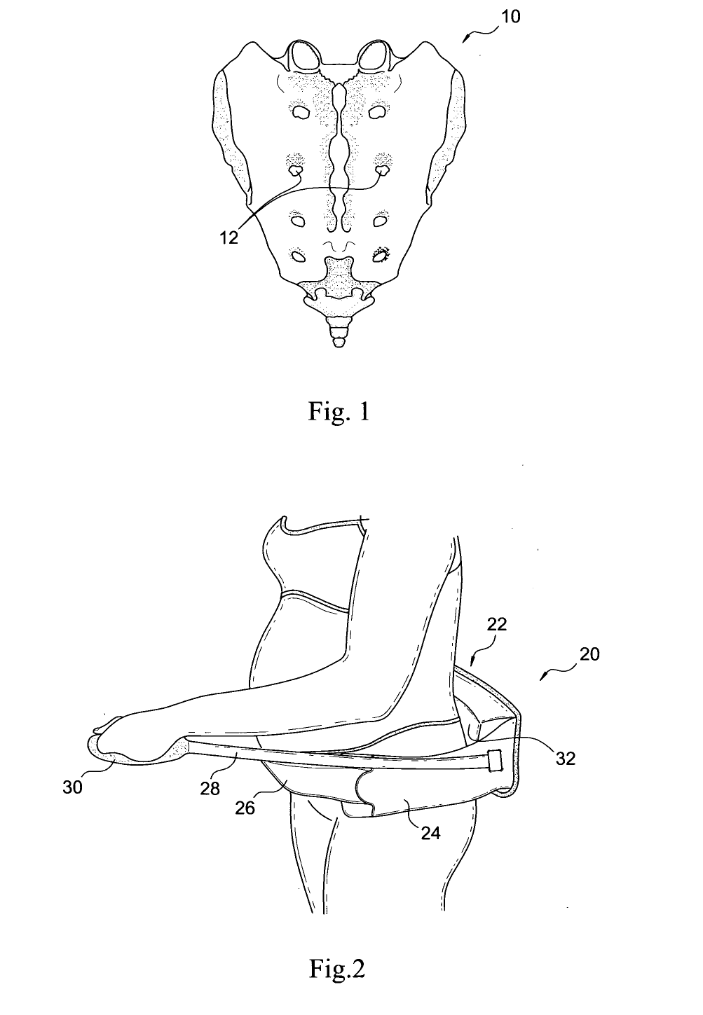

### DETAILED DESCRIPTION OF THE PRESENT INVENTION

In accordance with the present invention a system and method for relieving a woman experiencing labor pain and/or pains associated with pregnancy or menstrual period is provided. A device for relieving such pains according to the present invention is referred hereinafter as a device for relieving labor pain (DRLP). A DRLP of the present invention has a pressurizing unit, a harness, one or more optional driving motor, electric power supply, an optional controller and optional contraction sensor. The pressurizing unit has at least one pair of pressurizing elements spaced apart from each other by a predefined distance. The tip of a pressurizing element mimics according to the present invention the knuckle or the tip of a thumb of an acupressure therapist. The region enclosing the pressurizing elements that faces the user's body is referred hereinafter as the active face of the pressurizing unit. The harness structured and arranged to be attached to a user, such as a parturient or a pregnant woman, consists of a back segment, at least a portion of which is rigid. The rigid portion provides for firmly securing the pressurizing unit onto the body of the user such that the tips of the pressurizing elements face the targeted sacral foramina while the active face is disposed in front of her sacrum.

Reference is now made to FIG. 2 in which an isometric view of a DRLP according to an embodiment of the present invention is shown worn by a pregnant woman. Pressurizing unit, not shown, of DRLP 20 is housed in back segment 22 of harness 24. Elastic belt 26 provides for securing the pressurizing unit to the lower back of a user such that its active face faces the targeted area across the user's sacrum. Both side segments of harness 24 wraps the user's waist whilst the belt is fastened below her belly by means of a buckle, not shown. Stretching stripes 28, each of which having an end firmly attached to the harness, as well as the side segments of the harness are made of a firm fabric. Grabbing loops 30 each of which disposed at the free end of the respective stretching stripe are upholstered with soft fabric providing for conveniently holding while forwardly pulling them by the user. The pressurizing unit is such mounted onto the back segment that its active face is disposed adjacent to inner back face 32. Forwardly pulling stretching stripes 28 provides for fastening the back segment of the harness to the user's body concomitantly with forcing the pressurizing elements against the targeted area across her body while maintaining them in place during the contraction processes. The internal surface of inner face 32 is lined with soft layer, such as made of rubber foam. Alternatively or additionally, the faces of the pressurizing elements, not shown, are lined with soft layer, thereby minimizing the pain associated with pressing against hard bone that might be experienced by relatively skinny users. Optionally, the inner face of the back and side segments of the harness is wrapped with paper clothing providing for hygienic cover to be replaced prior to each and every usage.

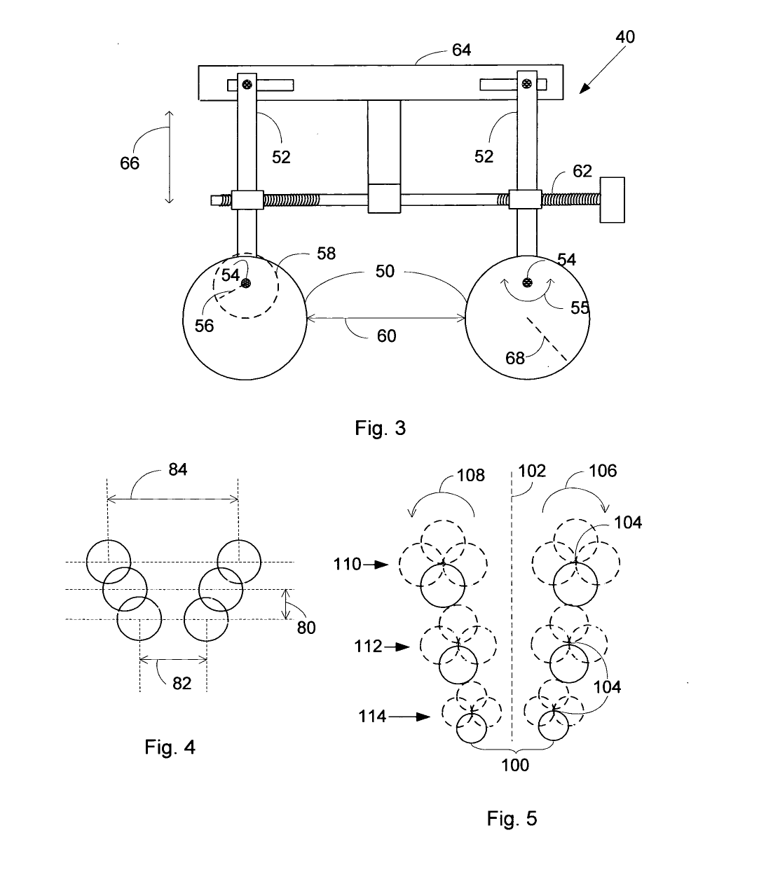

Reference is now made to FIG. 3 in which an elevational view of a segment of the pressurizing unit 40 of a DRLP according to an embodiment of the present invention is shown. Spherical pressurizing elements 50 are rotatably attached to connecting arms 52 respectively. Axle 54, which is connected by means of a ball bearing, not shown, to its respective pressurizing element provides for eccentrically rotating it clockwise or counterclockwise as shown by double arrow 55. The respective pressurizing element is further rotated in the same direction around its axis by means of a cogwheel mechanism as known. Such rotation made around the axis of the pressurizing element is referred hereinafter as a centric rotation. Axle 54 is spaced apart from the center of its respective pressurizing element by separation 56 having a predefined length. Rotating each pressurizing element by means of axle 54 brings about two simultaneous rotational motions, one of which is centric rotation whereas the other is eccentric. Namely, each pressurizing element rotates around its axis at a given predefined rotational speed, which is synchronized with an eccentric rotation at another predefined rotational speed in which its center moves along a circular path, such as circle 58. Similarly the outermost protruding point across the surface of each pressurizing element, referred hereinafter as the tip of this pressurizing element, rotates along a circular path having the same radius the length of which equals the length of separation 56. Therefore such rotation causes both pressurizing elements to press against contact points successively disposed along similar circles located across the surface of the user's body. Forwardly pulling the stretching stripes urges further the pressurizing elements towards the user's body thereby increasing the level of pressure exerted across an area enclosing each of these contact points at a time.

The spacing between both pressurizing elements, designated by double arrow 60, is decreased or increased by rotating screw 62 clockwise or counterclockwise respectively, thereby horizontally adjusting the placement of both axles 64 relative to the mounting frame of the pressurizing unit is accomplished. The worms along the two threaded segments of screw 62 are structured in opposite directions, thereby rotating the screw in one direction separates both pressurizing elements one from the other, whereas rotating the screw in the opposite directions brings them closer to each other. Such adjustment results in a corresponding positioning of the projection of axles 64 on the surface of the user's body relative to her medial sacral crest. Vertically adjusting the placement of the pressurizing elements relative to the user's sacrum is accomplished by means of a similar mechanism, not shown, attached to lever 64. Moving lever 64 back or forth relative to the mounting frame in directions shown by double arrow 66 provides for vertically adjusting the level in which axles 54 are disposed. The area across the user's body within which a pressure is exerted by each pressurizing element is linearly dependent on the length of radius 68. Therefore by suitably positioning the active face of the pressurizing unit relative to the sacrum; and suitably selecting: a. the lengths of radius 68, b. spacing 60 (the distance between the pressurizing elements) and c. separation 56 (the distance between the center of a pressurizing element and its axle); the tips of the rotating pressurizing elements press for a while, during the cycle time of each rotation, across a surface facing the targeted sacral foramina. Obviously the level of the applied pressure is dependent on the level of force exerted by the harness that is further enhanced by the forwardly stretched stretching stripes, as well as by the level of depth in which the respective tip can be urged against the soft tissues that cover the sacrum. Therefore the tips of the pressurizing element outwardly protrude off a plane that is parallel to the active face by a predefined level.

A DRLP according to a preferred embodiment of the present invention is hereby described with reference to FIG. 4 that is now made. The pressurizing unit of this DRLP has three pairs of eccentrically rotatable spherical pressurizing elements, which forms a two dimensional array. The pressurizing elements are such arranged that the circles along which their tips respectively rotate are schematically shown in FIG. 4. The center of each circle conforms to the projection across the surface of the user's body of the respective axis around which the corresponding pressurizing element rotates. Circles related to adjacent pressurizing elements that are located at the same side of the medial sacral crest partially overlap. The level of overlapping is determined by the distances between adjacent rows, such as represented by arrow 80, which designates the distance between the medial and bottom rows. Optionally these distances are adjustable by the user. The radius of the pressurizing elements imposes a constraint on the value of these distances to be larger than a minimal threshold permitting them to synchronously rotate, such that none of them blocks any of its neighbors. The distances between the centers of the circles arranged in a row, such as presented by arrow 82 which is the smallest distance, or arrow 84 that designates the largest distance separating between the centers corresponding to the pair of the topmost row, comply with extreme distance values between the BI32 sacral foramina that are normally found among women.

The three pairs of spherical pressurizing elements and the associated positioning mechanisms are mounted onto a mounting frame. One or more electrical DC motors with their respective driving gears are mounted onto the same mounting frame such that synchronously rotating the spherical pressurizing elements is provided. The rotational speed typically employed is in the range of a few cycles per second (CPS). Preferable are rotational speed in the range of 0.5-2 CPS. Optionally the shaft of an electrical motor is provided with a fan such that air cooling of the motor wile rotating is provided as known. Normally the motors are powered with DC voltage by employing a remote power supply and associated electrical cabling connected to a power connector installed on the mounting frame. Optionally an electrical battery which is further mounted unto the mounting frame provides for backup powering. Operating switches disposed on a side segment of the harness and two additional pressing switches respectively housed in the grabbing loops of the DLRP and an associated electrical circuitry provides for operating the pressurizing unit, activating the rotational motion of the pressurizing elements and optionally selecting the rotational speed and or direction in which the pressurizing elements rotate.

For operating the above described DRLP, a user first connects the electrical power cabling to the power supply and puts the DRLP on, such that the row of pressurizing elements that best fit in with her BL32 pressure points faces them. Such adjustment is accomplished by suitably placing and orienting the back face of the harness of the DRLP onto her sacrum. Slightly raising and/or lowering the back face provides for selecting the desired row of pressurizing elements to face the targeted sacral foramina. The elastic belt is further fastened below her belly. Further adjustment of the stretching level of the elastic belt, as well as for suitably positioning and orienting of the selected pair of pressurizing elements in place, is accomplished after the user experiences a few contractions during which she forwardly stretches the stretching stripes with her hands.

A user may choose to operate the DRLP either in a static or dynamic operational mode. In the static mode the user need not power the DRLP by connecting to the electrical power supply. She herself activates a continuous pressure to be exerted at the targeted points, as long as she forwardly stretches the stretching stripes while holding the grabbing loops in her hands. Preferably such stretching is applied concomitantly with forwardly bending her shoulders and/or the rest of her upper body while keeping her arms stretched ahead, such that her fists are laid on a table or a back of a chair. In the dynamic mode the user manually activates the rotation of the pressurizing elements by means of a pressing switch disposed at one of the, or both, grabbing loops held in her hand. Forwardly stretching the stretching stripes is similarly accomplished as in the static operational mode. Due to the rotational motion of the pressurizing elements, the tip of the pressurizing element that is closest to the respective desired pressure point presses against it as long as it reaches its position in each and every rotation made. Optionally the user changes the distances between two adjacent rows of pressurizing elements, as well as the spacing between the pressurizing elements to best fit with the locations of her BI32 sacral foramina. Such adjustments are accomplished in the same manner as described hereinabove.

A DRLP of the present invention need not have any driving motors for rotating the pressurizing elements. A DRLP in accordance with another embodiment of the present invention has three pairs of pressurizing elements arranged in two dimensional array. The tips of the pressurizing elements of the medial row are arranged such that they are accommodated to press against the BI32 pressure points considering the most probable geometrical shape and dimensions of the womanly sacrum. The tips of the upper row conform with larger separation between the foramina, whereas the tips of the lower row conform with smaller separation. All three rows are provided with an adjustment mechanism that enables continuously changing the respective separation. Namely this mechanism provides for horizontally moving each tip. The ranges within which the lengths can be changed are such that ranges of adjacent rows overlap. Additionally each tip can be further vertically moved upwards or downwards by means of its respective vertical adjusting mechanism. A DRLP in accordance with another embodiment of the present invention is further provided with pressing mechanism including one or two linear actuators and associated biasing springs respectively connected to each pair of pressurizing elements, as known. Such pressing mechanism is electrically activated by the user thereby pressurizing the targeted sacral foramina is further electrically effected. Activation of such electrically effected pressurizing is accomplished by means of a pressing switch embedded in the grabbing loops of the DRLP.

The user or her supporting partner may fine tune the length separating between the tips of a selected row to better conform with her targeted sacral foramina. The user or her partner can further fine tune the vertical position of each of the selected tips. At this stage the user or her partner can push backwards the remaining two rows that do not conform to the targeted sacral foramina by means of a mechanical avoiding mechanism which is selectively operative for each row. Exemplary such mechanism comprises a lever pivotally attached to the mounting frame that is movable between two positions. In one position the tips forwardly protrudes towards the back of the user, whereas in the second position the tips are oriented vertically, thereby avoid touching the surface of the user's body. Such fine tuning is accomplished by a few experiments or trials that may take a number of contractions in which the user operates the DRLP as described hereinabove in the static operational mode. By the end of the adjusting process the user may continue in operating the DRLP by employing the static operational mode.

A DRLP in accordance with another preferred embodiment of the present invention has an integral controller and is further equipped with either integral contraction sensor or is operated in combination with a contraction sensor. Any contraction sensor, which is actually an electromagnetic or optical strain gage that is available in the market place can be employed for this purpose. The contraction sensor is either embedded in a dedicated segment of the harness or otherwise attached to the belly of the user. The contraction sensor is further electrically connected to the controller of the DRLP. When a signal transmitted from the contraction sensor is interpreted as indicating a contraction as known, the controller automatically activates the motor or motors driving the rotational motion of the pressurizing elements. Optionally other sensor typically employed for monitoring the state of the fetus, such as sound and/or ultrasound sensors are attached to the user's belly by means of the harness and further connected to the respective monitoring station as known.

For operating this DRLP the user has to be suitably equipped with the contraction sensor, as known, and the DRLP suitably put on and fastened as described hereinabove. Then she activates the DRLP by putting its operating switch on. From now on she just has to forwardly stretch the stretching stripes whenever she experiences contractions and the rest of operation goes automatically on. In such cases the user might be less loaded and therefore more open to fine tune the positioning and orientation of the selected pressurizing elements against the targeted pressure points.

### Example 1

A DRLP according to an embodiment of the present invention was manufactured and clinically tested. Reference is now made to FIG. 5 in which a scheme describing the setup of the pressurizing elements of this DRLP is shown. For the sake of simple description, the dimensions shown in FIG. 5 are arbitrary. Each pressurizing element is shown being at four exemplary rotational angles, three of which are designated by dashed circles. The pressurizing unit of this DRLP has three pairs of spherical pressurizing elements, such as pair 100. The pressurizing elements of a pair are symmetrically disposed at both sides of line 102 that is intended to be aligned along the medial sacral crest of a user. All the pressurizing elements are eccentrically rotatable simultaneously by means of a common DC motor and a set of cogwheels, not shown, suitably arranged as known. Axles, such as axles 104 each of which is tangentially attached to a respective spherical pressurizing element provides for its rotation. An integral tank and piping, not shown, structured and arranged for dispensing lubricants, such as massaging oil or gel typically utilized during manual acupressure or massaging, is further mounted onto the mounting frame of this DRLP. Activating the dispensing of lubricants is accomplished by the user by means of an activation lever installed at the topside of the back segment of the harness.

All three pressurizing elements that are disposed at the same side of line 102 synchronously rotate at the same direction as is respectively indicated by arrows 106 and 108. The rotation of the entire set of pressurizing elements is synchronous at a selectable rotational speed. The radii measured in centimeters (cm) and the distances separating between the axles of the respective pressurizing elements of a pair, which is also measured in cm, are given in table 1 below:

TABLE 1
Pairs of pressurizing elements - radii and distances

| Pair No. | Radius [cm] | Distance [cm] |
|---|---|---|
| 110 | 1 | 9 |
| 112 | 0.75 | 7.7 |
| 114 | 0.5 | 5 |

The distance separating between the axles of adjacent pairs is 3 cm. The value of the rotational speed in which all the pressurizing elements simultaneously rotate is selectable by the user. The user is able to choose among the values of 0.5, 1 and 2 CPS, by means of a dedicated switch disposed at a side segment of the harness. Activating the rotational motion is accomplished by the user by means of any of two pressing switches each of which housed within the respective grabbing loop. By vertically displacing the back segment of the harness relative to the sacrum of a user she is able to adjust the positioning of a selected pair among the pairs 110-114, which best conforms with her BI32 sacral foramina.

### Example 2

A DRLP such as described in example 1 above was employed in clinical trials that are hereby briefly described. In accordance with the protocol of the clinical trial, a participating woman puts on the DRLP such that its pressurizing elements respectively face her BI31, BI32 and BI33 sacral foramina. Then she initially tries to adjust and align the pressurizing unit to be positioned in the best alignment and location relative to her sacrum during a few experienced contractions. Aligning and positioning is effected by slightly translating and/or rotating the back segment of the harness relative to her body concomitantly with adjusting the level of stretch applied by the elastic belt. In operation the rotational motion was activated according to the protocol of the trial for a few minutes during each and every contraction occurring along this time. By the end of a predefined time interval the rotational motion of the pressurizing elements is paused by avoiding any such activation for a second predefined time interval. At the end of such pause the rotational motion of the pressurizing elements is intermittently activated for each and every contraction occurring along a third time interval. Two parturients out of thirty three who took part in this trial could not recognize at all, or hardly recognized any relieve in the experienced labor pains. However nine of the participants in this trial reported a substantial relieve in the experienced labor pains, whereas twenty two of them reported a significant relieve in the labor pains.

1. A device for relieving labor pain (DRLP) having a harness and a pressurizing unit, wherein the active face of said pressurizing unit structured and arranged to face the sacral foramina of a user, said DRLP comprising at least one pair of pressurizing elements, wherein each of said pressurizing elements has a tip rotatable along a segment of a circular path having a predefined radius, and wherein said harness provides for attaching said pressurizing unit to the body of a user, and wherein said harness structured and arranged to wrap the waist of said user, said harness comprises:
a back segment for housing said pressurizing unit;
two stretching stripes firmly attached to said harness for urging said tips towards targeted sacral foramina of said user, the free end of each of said two stretching stripes adapted and arranged to be held by a hand of said user.

2. A DRLP as in claim 1, wherein each pressurizing element of said at least one pair of pressurizing elements is automatically rotatable at least one rotational speed.

3. A DRLP as in claim 2, wherein said at least one rotational speed is associated with an eccentric rotation.

4. A DRLP as in claim 2, wherein said at least one rotational speed is associated with a centric rotation.

5. A DRLP as in claim 1, wherein the spacing between axes around which each of said pressurizing elements eccentrically rotates is changeable.

6. A DRLP as in claim 1, further comprising a controller for automatically activating said rotation, wherein said controller adapted and arranged for receiving signals from a sensor adapted and arranged to be activated by a labor contraction.

7. A DRLP as in claim 7, in combination with a contraction sensor.

8. A DRLP as in claim 1, wherein said pressurizing unit further comprises at least another pair of pressurizing elements each of which respectively having a tip, and wherein all of said pressurizing elements are arranged in a two dimensional array.

9. A DRLP as in claim 8, wherein the spacing between adjacent rows of said two dimensional array is changeable.

10. A DRLP as in claim 1, wherein said tips adapted and arranged to fit in with targeted points across the surface of the body of said user facing her sacral foramina.

11. A DRLP as in claim 10, wherein each of said tip is vertically movable relative to said back segment.

12. A DRLP as in claim 11, wherein each of said tip is horizontally movable relative to said back segment.

13. A method for pressing at acupressure points facing targeted sacral foramina of a user, for relieving labor pains and/or pains associated with pregnancy or menstrual period, according to which the tip of at least one pressurizing element urged towards one of said targeted sacral foramina, said method comprising repeatedly rotating said tip along a circular path a segment of which closely disposed adjacent to said one sacral foramina, wherein said at least one pressurizing element is one of at least one pair of pressurizing elements, and wherein said at least one pair of pressurizing elements housed in a back segment of a harness adapted and arranged to wrap the waist of said user, and wherein said urging accomplished by said user by forwardly pulling a pair of stretching stripes each of which firmly attached to said harness.

14. A method as in claim 13, further comprising axially rotating said at least one pressurizing element.

15. A method as in claim 13, further comprising adjusting the placement of said at least one pressurizing element relative to any of the targeted sacral foramina by translating said at least one pressurizing element relative to said back segment.

16. A method as in claim 13, wherein said urging is further electrically activated by said user.

17. A method as in claim 13, wherein said rotating automatically activated by means of a controller adapted and arranged for receiving signals generated by a contraction sensor.
